(19) United States
(12) Patent Application Publication
(10) Pub. No.: US 2009/0092859 A1
(43) Pub. Date: Apr. 9, 2009

(54) Electrode assembly, secondary battery having the electrode assembly, and methods of manufacturing the electrode assembly

(76) Inventor: Tae-Won Kim, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/216,897

(22) Filed: Jul. 11, 2008

(30) Foreign Application Priority Data
Oct. 5, 2007 (KR) 10-2007-0100371

(51) Int. Cl. H01M 4/58; H01M 10/00; H01M 4/04

(52) U.S. Cl. 429/7; 429/94; 429/246; 429/223; 429/218.1; 429/220; 29/623.1

(57) ABSTRACT

An electrode assembly which prevents materials from being damaged and improves safety by joining a plate and an electrode tab created by a high-frequency induction heating method. Also included is a secondary battery using the electrode assembly. The electrode assembly is formed by stacking and winding a positive electrode plate to which a positive electrode tab is joined, a negative electrode plate to which a negative electrode tab is joined, and a separator, and is characterized in that a bonded side is formed by surface-welding the entire welded part of either the positive electrode tab and the positive electrode plate or the negative electrode tab and the negative electrode plate, or both of the positive electrode tab and the positive electrode plate and the negative electrode tab and the negative electrode plate forming a bonded side.

### CLAIM OF PRIORITY

This application makes reference to, incorporates the same herein, and claims all benefits accruing under 35 U.S.C. §119 from an application for ELECTRODE ASSEMBLY, SECONDARY BATTERY USING THE SAME, MANUFACTURING METHOD OF ELECTRODE ASSEMBLY AND ELECTRODE MANUFACTURED THEREBY earlier filed in the Korean Intellectual Property Office on Oct. 5, 2007 and there duly assigned Serial No. 2007-0100371.

### BACKGROUND OF THE INVENTION

1. Field of the Invention

The present invention relates to an electrode assembly, a secondary battery including the electrode assembly, methods of manufacturing an electrode assembly, and electrode assemblies manufactured by these methods, and more particularly, to an electrode assembly which prevents machines and materials from being damaged and improves safety by joining electrode plates and electrode tabs together by high-frequency induction heating, a secondary battery including the electrode assembly, methods of manufacturing an electrode assembly, and electrode assemblies manufactured by these methods.

2. Discussion of the Related Art

As information technology has been rapidly changed and the need for swift access to information has increased, this has increased users' requests for portable electronic equipment which is small and light and has high capacity.

The portable electronic equipment, such as PDAs, mobile phones, camcorders and the like, has high energy density devices and use rechargeable secondary batteries as their main power sources.

Due to the factors of power supply time, size, weight and the like, a secondary battery has been recognized as a very important factor in determining portability and mobility of the portable electronic equipment.

A secondary battery is being designed to increase the power supply time and to be small and light. Further, a secondary battery includes a protective circuit board on which a protective device is mounted to extend a secondary battery life and to prevent an accident.

Examples of a secondary battery include a nickel-zinc battery, a nickel-cadmium battery, a nickel-hydrogen battery, and a lithium secondary battery. Among these batteries, the lithium secondary battery which has a high operating voltage and high energy density per unit weight is widely used.

The lithium secondary battery is used by connecting a protective circuit module to a bare cell formed by receiving an electrode assembly in a container formed of a substance, such as aluminum and the like, the container is finished using a cap assembly, injecting an electrolyte inside the container and sealing the container.

The lithium secondary batteries are classified as a cylindrical shape, a prismatic shape and a pouch shape according to the shape of the container and are classified as a lithium ion battery and a lithium polymer battery according to the electrolyte.

Generally, the electrode assembly received in the container has a jelly-roll shape in which a positive electrode plate, a negative electrode plate and a separator between the two plates are stacked and wound.

The positive electrode plate is formed by coating a positive electrode collector formed of an aluminum or aluminum alloy with a positive electrode active material and the negative electrode plate is formed by coating a negative electrode collector formed of copper or copper alloy with a negative electrode active material.

Then, on each of the positive electrode plates and negative electrode plates, a non-coating portion, which is not coated with the active material, is formed. An electrode tab for electrically connecting the electrode assembly to the outside is welded to each non-coating portion.

That is, a positive electrode tab is welded to the positive electrode non-coating portion formed on the positive electrode plate and a negative electrode tab is welded to the negative electrode non-coating portion formed on the negative electrode plate.

Then, since the electrode tab is formed of nickel of good conductivity, the electrode tab and the electrode plate, which differ from each other in materials, are welded together.

That is, the positive electrode plate, made of an aluminum substance is welded to the positive electrode tab of a nickel substance, and the negative electrode plate, made of a copper substance, is welded to the negative electrode tab of the nickel substance.

It is difficult to join metals of different materials together by resistance welding. Thus, the plate and the electrode tab are joined together by ultrasonic welding. However, the ultrasonic welding may easily generate metal scraps upon welding, and therefore it may cause an internal short. Moreover, since the ultrasonic welding is a point welding method, a joint may easily separate by an external impact and generate contact resistance and internal resistance.

Therefore, to secure a sufficient area of the joint, the ultrasonic welding needs to be repeatedly performed. The repeated performance may damage materials or generate a loss during the process.

Moreover, a local nonexistent joint may occur by the passage of time or wear but it is difficult to check the nonexistent joint from appearance and it is necessary to perform a destructive test.

### SUMMARY OF THE INVENTION

The present invention provides an electrode assembly, which is formed by stacking and winding a positive electrode plate welded to a positive electrode tab, a negative electrode plate welded to a negative electrode tab, and a separator, characterized in that either the positive electrode tab and the positive electrode plate or the negative electrode tab and the negative electrode plate, or both of the positive electrode tab and the positive electrode plate and the negative electrode tab and the negative electrode plate form a bonded side by surface-welding of the entire joint.

Further, the present invention provides an electrode assembly, which is formed by stacking and winding a positive electrode plate welded to a positive electrode tab, a negative electrode plate welded to a negative electrode tab, a separator, and a secondary battery including an outer case receiving the electrode assembly, characterized in that the whole welded part, which is formed by welding any one or both of the positive electrode tab and positive electrode plate and the negative electrode tab and negative electrode plate, forms a bonded side being surface-welded.

Further, the bonded side is characterized by being formed by a high-frequency induction heating method.

Further, the bonded side is characterized by being formed to have an area corresponding to an induction coil for joining the positive electrode plate and the positive electrode tab together or the negative electrode plate and the negative electrode tab together by the high-frequency induction heating method.

Further, the positive electrode tab is formed of nickel and the positive electrode plate is formed of aluminum.

As described above, in the present invention, the positive electrode plate and the positive electrode tab or the negative electrode plate and the negative electrode tab are joined together by the high-frequency induction heating method, so that the positive electrode and negative electrode materials are prevented from being damaged and the safety is improved.

Further, the large joint is easily secured, to prevent a loss in manufacturing efficiency due to the repeat welding to secure the large joint.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1A is an exploded perspective view of an electrode assembly according to an embodiment of the present invention;

FIG. 1B is a plan view of the electrode assembly of FIG. 1A;

FIG. 2A is a plan view of the constitution according to a first embodiment of the present invention, that explains a method of joining a plate and an electrode tab together by a high-frequency induction heating method;

FIG. 2B is a side view of the constitution according to the first embodiment of FIG. 2A;

FIG. 3 is a plan view of the constitution according to a second embodiment of the present invention, that explains a method of joining a plate and an electrode tab together by a high-frequency induction heating method;

FIGS. 4A and 4B are a plan view and a side view of the constitution of the first embodiment of the present invention, being joined by the high-frequency induction heating method; and

FIG. 5 illustrates an example of a secondary battery including the electrode assembly according to the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the thicknesses of layers and regions are exaggerated for clarity.

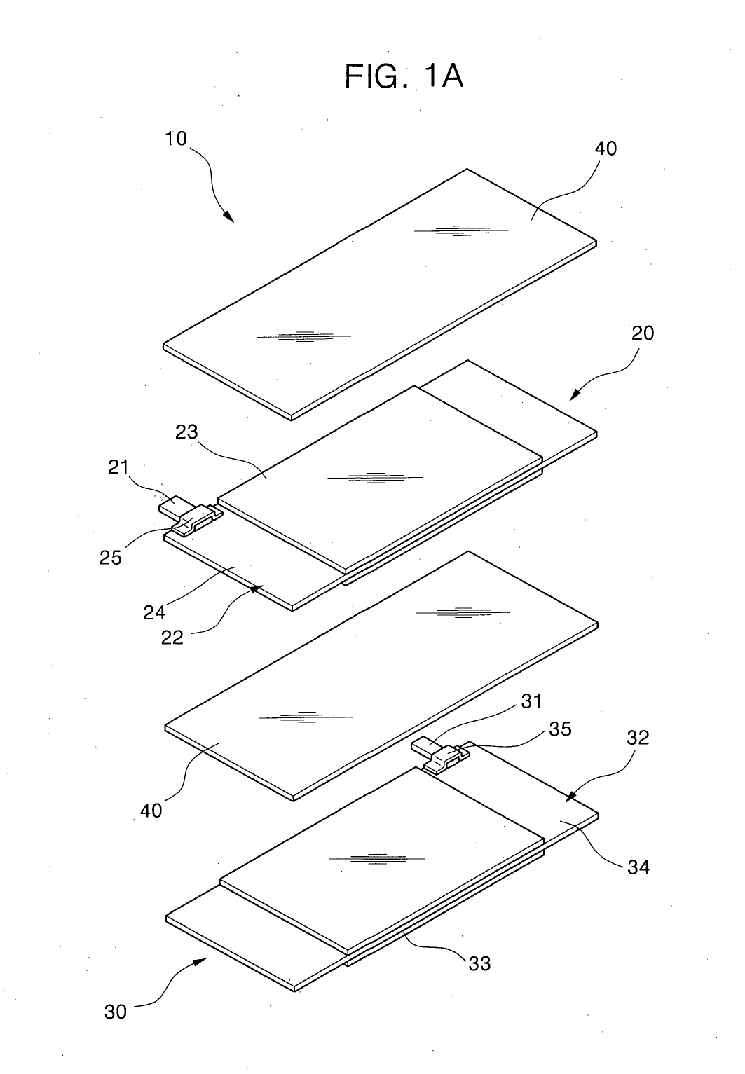

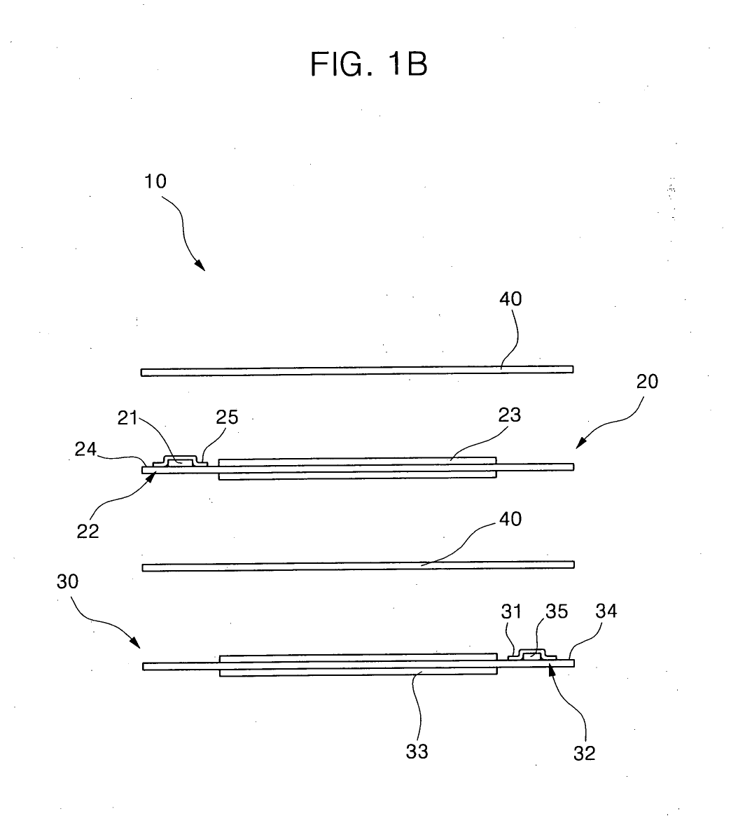

FIGS. 1A and 1B is an exploded perspective view and a plan view of an electrode assembly 10 according to an embodiment of the present invention.

Referring to FIGS. 1A and 1B, the electrode assembly 10 includes a first electrode plate 20 (hereinafter, referred to as a ‘positive electrode plate’), a second electrode plate 30 (hereinafter, referred to as a ‘negative electrode plate’), and a separator 40.

A positive electrode tab 21 is joined at a side end of the positive electrode plate 20 and a negative electrode tab 31 is joined at a side end of the negative electrode plate 30.

On the positive electrode plate 20, there are formed a positive electrode collector 22 collecting electrons generated by a chemical reaction and transferring the electrons to an external circuit, a positive electrode coating portion 23 formed of a positive electrode active material coating one or both sides of the positive electrode collector 22 and constructed in a structure of occluding or separating lithium ions, and a positive electrode non-coating portion 24 of the positive electrode collector 22 which is not coated with the positive electrode active material so that the positive electrode collector 22 is revealed as it is.

The positive electrode collector 22 may use stainless steel, nickel, aluminum, titanium or an alloy thereof or it may use a resultant of surface-treating of the surface of aluminum or stainless steel with carbon, nickel, titanium or silver. Preferably, the positive electrode collector 22 may use aluminum or aluminum-alloy among the aforementioned substances.

The form of the positive electrode collector 22 may be foil, film, sheet, punched substance, porous substance or a foaming agent. The thickness of the positive electrode collector 22 is generally 1 to 50 μm, and preferably 1 to 30 μm. The present invention does not limit the form and thickness of the positive electrode collector.

The positive electrode coating portion 23 is formed of the positive electrode active material capable of occluding or separating the lithium ions. Preferably, the positive electrode active material may be at least one selected from cobalt, manganese and nickel and one or more of a composite oxide with lithium.

The positive electrode tab 21 formed of nickel and transferring the electrons collected in the positive electrode collector 22 to the external circuit is joined to the positive electrode non-coating portion 24 by the high-frequency induction heating method.

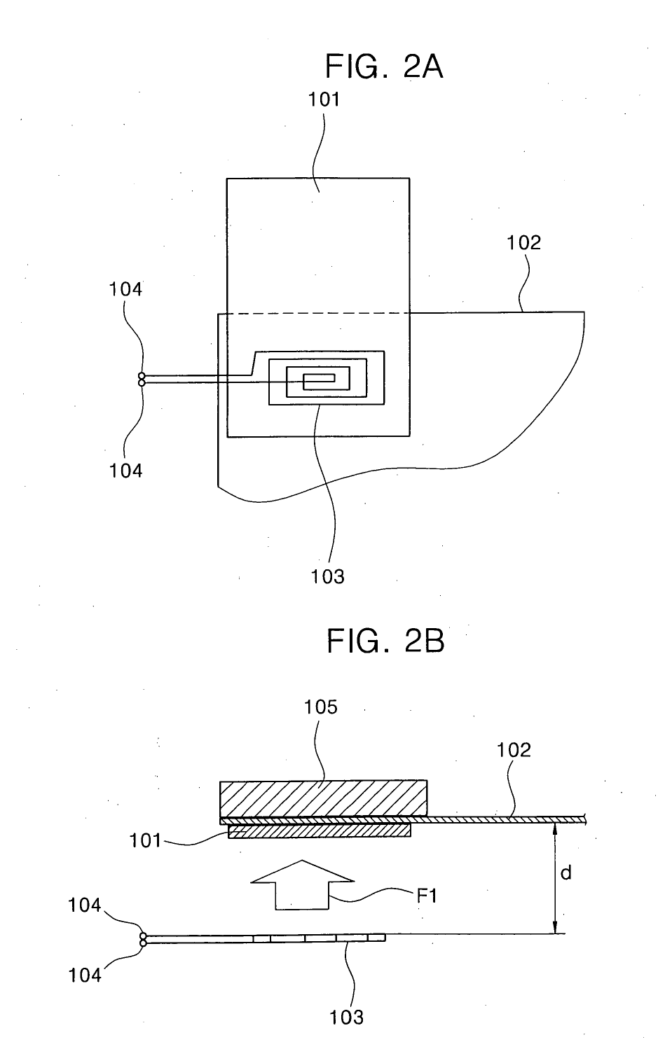

The joining method using the high-frequency induction heating method will be described later, in detail, with reference to FIG. 2.

A protective member 25 may be formed in a top side of the positive electrode plate 20 where the positive electrode tab 21 is joined. The protective member 25 is provided to prevent a short by protecting the joint and, preferably, it may be a thermo-stable material, for example, polymer resin such as polyester. Also, the protective member 25 has the width and length to completely close the positive electrode tab 21 joined to the positive electrode non-coating portion 24.

On the negative electrode plate 30, there are formed a negative electrode collector 32 collecting the electrons generated by a chemical reaction and transferring the electrons to an external circuit, a negative electrode coating portion 33 formed of a negative electrode active material coating one or both sides of the negative electrode collector 32 and constructed in a structure of occluding or separating the lithium ions, and a negative electrode non-coating portion 34 of the negative electrode collector 32 which is not coated with the negative electrode active material so that the negative electrode collector 32 is revealed as it is.

The negative electrode collector 32 may use stainless steel, nickel, copper, titanium or an alloy thereof or it may use a product of surface-treating the surface of copper or stainless steel with carbon, nickel, titanium or silver. Preferably, the negative electrode collector 32 may use copper or copper-alloy among the aforementioned substances.

The form of the negative electrode collector 32 may be foil, film, sheet, punched substance, porous substance or a foaming agent. The thickness of the negative electrode collector 32 is generally 1 to 50 μm, and preferably 1 to 30 μm. The present invention does not limit the form and thickness of the positive electrode collector.

The negative electrode coating portion 33 is formed of the negative electrode material capable of occluding or separating the lithium ions. Preferably, the negative electrode active material may use carbon materials such as crystal carbon, amorphous carbon, carbon complex, carbon fiber and the like, lithium metals, lithium alloys and the like.

For example, the amorphous carbon include hard carbon, cokes, meso-phase carbon micro beads (MCMB) plasticized under 1500 □ C, mesophase pitch-based carbon fibers (MPCF) and the like.

The crystal carbon includes graphite-based materials, and specifically, natural graphite, graphitized cokes, graphitized MCMB, graphitized MPCF and the like.

The lithium alloy may use an alloy of lithium and aluminum, zinc, bismuth, cadmium, antimony, silicon, lead, tin, gallium or indium.

The negative electrode tab 31 formed of nickel and transferring the electrons collected in the negative electrode collector 32 to the external circuit is joined to the negative electrode non-coating portion 34 by the high-frequency induction heating method.

The joining method using the high-frequency induction heating method will be described later, in detail, with reference to FIG. 2.

A protective member 35 may be formed in a top side of the negative electrode plate 30 where the negative electrode tab 31 is joined.

The protective member 35 is to prevent a short from occurring by protecting the joint and, preferably, it may be a thermo-stable material, for example, polymer resin such as polyester.

Further, the protective member 35 has the width and length to completely close the negative electrode tab 31 joined to the negative electrode non-coating portion 34.

The separator 40 is generally formed of thermoplastic resin, such as polyethylene (PE), polypropylene (PP) and the like.

In the aforementioned porous structure, when it is proximate to the melting point of the thermoplastic resin by the temperature rise inside the battery, the separator 40 is melted and closed to become an insulating film.

When the separator 40 is changed to the insulating film, the movement of the lithium ions between the positive electrode plate 20 and the negative electrode plate 30 is cut off and an electric current cannot flow anymore and the temperature inside the battery stops increasing.

FIGS. 2A and 2B are a plan view and a side view of a first embodiment of the present invention, for explaining a method of joining an electrode plate 102 and an electrode tab 101 together by the high-frequency induction heating method.

Referring to FIGS. 2A and 2B, the electrode plate 102 and the electrode tab 101 are arranged between a fixing jig 105 and an induction coil 103.

Alternatively, after the electrode plate 102 and the electrode tab 101 are arranged, the fixing jig 105 and the induction coil 103 may be respectively arranged at either side of the electrode plate 102 and the electrode tab 101.

After the electrode plate 102 is arranged at one side of the fixing jig 105, the electrode tab 101 may be arranged on the electrode plate 102, and after the electrode tab 101 is arranged at one side of the fixing jig 105, the electrode plate 102 may be arranged on the electrode tab 101.

A terminal 104 of the induction coil 103 is connected to an external power source (not shown) and receives the power applied from the external power source (not shown).

The electrode tab 101 and the electrode plate 102 may have a positive polarity or a negative polarity. When the electrode tab 101 and the electrode plate 102 have the positive polarity, the electrode plate 102 may be formed of an aluminum material and the electrode tab 101 may be formed of nickel.

When the electrode tab 101 and the electrode plate 102 have the negative polarity, the electrode plate 102 may be formed of copper and the electrode tab 102 may be formed of nickel. Further, the electrode plate 102 may be coated with an active material or not. However, when there is a risk in that the active material is damaged or deteriorated during a joining process, preferably, the joining process may be performed in the state where the electrode plate 102 is not coated with the active material.

In the aforementioned state, when a high-frequency current from the external power source (not shown) is rapidly electrified to the induction coil 103, magnetic flux generated by the high-frequency current induces an eddy current of high density through the electrode tab 101 and the electrode plate 102.

Since the eddy current is strongly generated on the electrode tab 101 and the surface of the electrode plate 102, the electrode tab 101 and the surface of the electrode plate 102 are heated.

Further, an electromagnetic force F1 in proportion to the electrifying current and the magnetic flux density is generated, whereby pressure is momentarily applied to the electrode tab 101 and the electrode plate 102. Therefore, the heat generated by the eddy current and the electromagnetic force F1 generated by the flow of the electric current heat and pressurize the electrode tab 101 and the electrode plate 102 are to be joined together.

In general, since the frequency of the high-frequency current is used within the range of 50 Hz to 1M Hz, and the distance d between the induction coil 103 and the electrode plate 102 is within the range of 0.1 to 50 mm, preferably, the joining may be performed within the ranges.

Depending on the materials of the electrode tab 101 and the electrode plate 102 to be joined together, the electrifying time, the frequency of the high-frequency current, and the distance d between the induction coil 103 and the electrode plate 102 may be variously set.

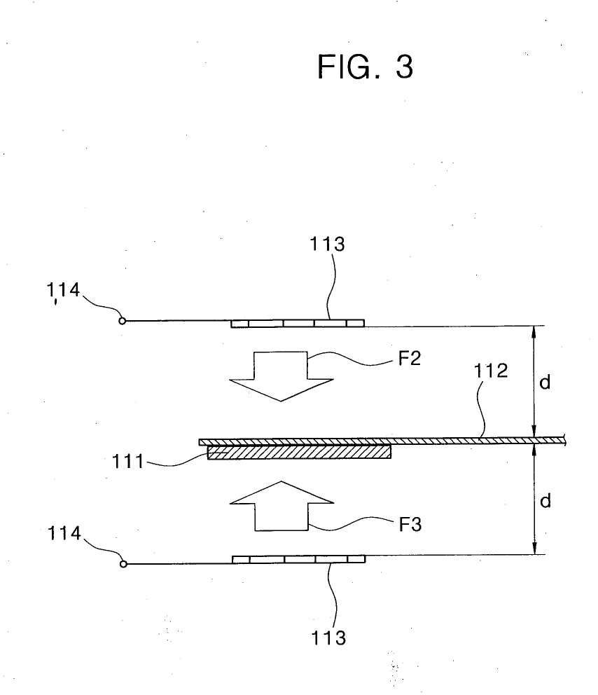

FIG. 3 is a plan view of a second embodiment of the present invention, for explaining the method of joining a electrode plate 112 and an electrode tab 111 together by the high-frequency induction heating method.

Unlike the first embodiment, the second embodiment illustrates the method of joining the electrode tab 111 and the electrode plate 112 together when no jig is included.

Referring to FIG. 3, the electrode tab 111 and the electrode plate 112 to be joined together are arranged between two inductor coils 113 each including a terminal 114 for connection to an external power source. Also, after the electrode tab 111 and the electrode plate 112 are arranged, the induction coils 113 may be respectively arranged at either side of the electrode tab 111 and the electrode plate 112.

Since each of the constituting elements 111, 112, 113 and 114 of the second embodiment has the same constitution and acting-effects as those of each of the constituting elements 101, 102, 103 and 104 of the first embodiment, no further description will be presented.

In the first embodiment, the electromagnetic force F1 generated in proportion to the electrifying current and the magnetic flux density pressurizes the electrode tab 101 and the electrode plate 102 that are to be joined together in only one direction.

However, in the second embodiment, since the induction coils 113 are respectively positioned at both side of the electrode tab 111 and the electrode plate 112 to be joined together, electromagnetic forces F2 and F3 generated in proportion to the electrifying current and the magnetic flux density are capable of pressurizing the electrode tab 111 and the electrode plate 112 in both directions.

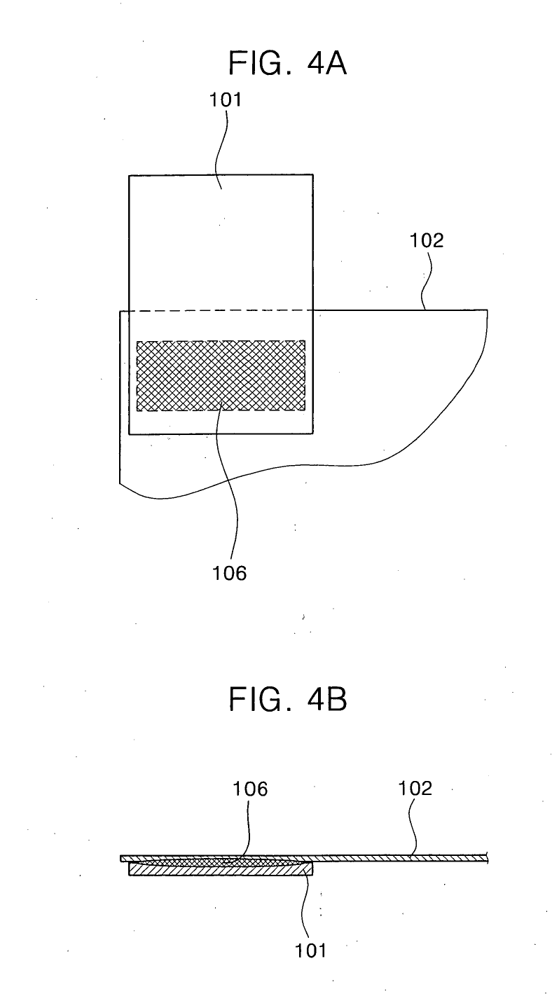

FIGS. 4A and 4B are a plan view and a side view of the case where the electrode tab 101 and the electrode plate 102 are joined together the high-frequency induction heating method according to the first embodiment.

Referring to FIGS. 4A and 4B, when the electrode tab 101 and the electrode plate 102 are joined together by the high-frequency induction heating method, a bonded side 106 to be joined corresponding to the induction coil is formed.

The bonded side 106 may have various shapes, depending on the shape and area of the induction coil to heat and pressurize the electrode tab 101 and the electrode plate 102. Therefore, the area of the bonded side 106 can be easily adjusted by making the area of the induction coil to be small when a contact area of the electrode tab 101 and the electrode plate 102 is small, or making the area of the induction coil to be broad when the contact area of the electrode tab 101 and the electrode plate 102 is large.

Further, when it is necessary to have a large bonded side, the materials are prevented from being damaged since the large bonded side can be secured by the momentary heating and pressing not the repeated welding such as conventional ultrasonic welding. Further, the metal scraps generated upon the joining can be controlled to be favorable for safety.

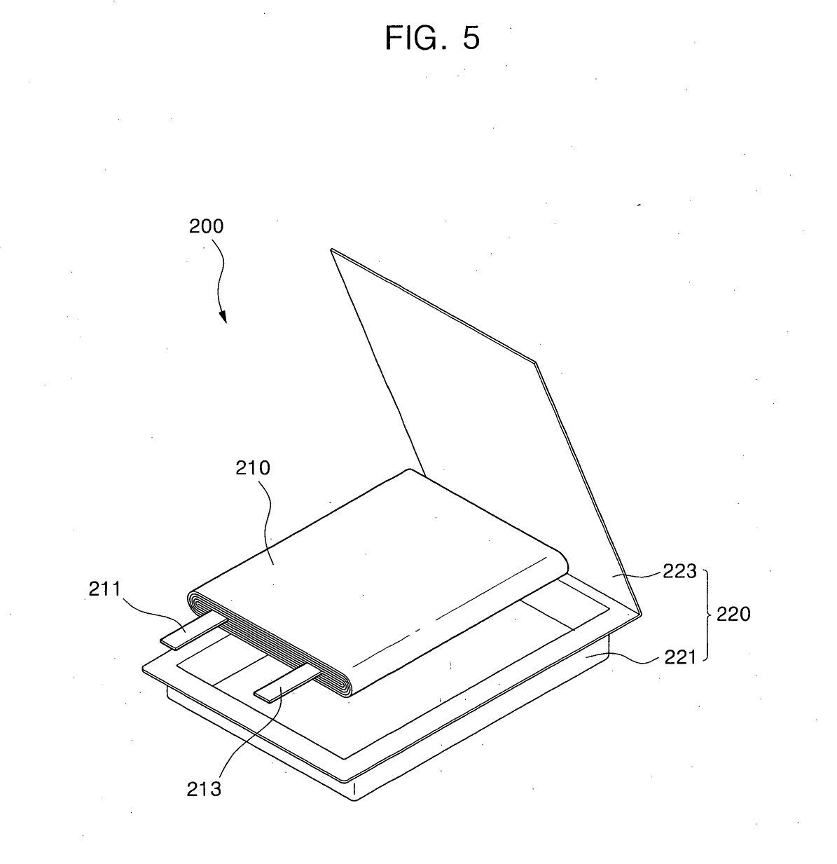

FIG. 5 illustrates an example of a secondary battery 200 including the electrode assembly according to the present invention.

Referring to FIG. 5, the secondary battery 200 comprises an electrode assembly 210 and an outer case 220 receiving the electrode assembly 210.

The electrode assembly 210 has the above-described constitution, and the outer case 220 has a pouch shape as shown. The outer case 220 includes a bottom outer case 221 in which the electrode assembly 210 is safely held, and a top outer case 223 sealing the bottom outer case 221.

Further, the outer case 220 may be a cylindrical shape or a prismatic shape as well as the pouch shape. The outer case 220 may have a structure in which an insulating layer, a metal layer and a protective layer are basically sequentially stacked.

The insulating layer is a most inner layer and formed of a substance layer with insulating properties and thermal-adhesiveness. The metal layer prevents the permeating of water and the loss of an electrolyte. The protective layer is a most outer layer and protects the whole body of the battery.

The insulating layer positioned at the edges inside the top outer case 221 and the bottom outer case 223 is melted by heat so that the top outer case 221 and the bottom outer case 223 are connected to each other to be sealed.

A positive electrode tab 211 and a negative electrode tab 213 drawn from the electrode assembly 210 protrude outside the outer case 220. The protruding positive electrode tab 211 and negative electrode tab 213 are electrically connected to external circuits.

The secondary battery 200 may further comprise a protective circuit module on which a protective device is mounted to extend a battery life and to prevent an accident.

Further, when the outer case 210 is in a prismatic shape or a cylindrical shape, the secondary battery 200 may be formed by allowing the electrode assembly to be received in the can of a metal material, such as aluminum, which is formed by a dip drawing method, finishing the top end of the can by the cap assembly, and injecting the electrolyte.

The invention has been described using preferred embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. An electrode assembly which is formed by stacking and winding a positive electrode plate to which a positive electrode tab is joined, a negative electrode plate to which a negative electrode tab is joined, and a separator, comprising:
a bonded side formed by surface-welding an entire welded part of either the positive electrode tab and the positive electrode plate or the negative electrode tab and the negative electrode plate, or both of the positive electrode tab and the positive electrode plate and the negative electrode tab and the negative electrode plate forming a bonded side.

2. The electrode assembly according to claim 1, wherein the bonded side is formed by high-frequency induction heating.

3. The electrode assembly according to claim 1, wherein the bonded side is formed to have a corresponding area to an induction coil for joining the positive electrode plate and the positive electrode tab together or the negative electrode plate and the negative electrode tab together by the high-frequency induction heating.

4. The electrode assembly according to claim 1, further comprising:
a protective member provided on a top surface of a portion where each of the positive electrode tab and the negative electrode tab is joined.

5. The electrode assembly according to claim 1, wherein the positive electrode tab and the positive electrode plate are formed of different metals.

6. The electrode assembly according to claim 5, wherein the positive electrode tab is formed of nickel and the positive electrode plate is formed of aluminum.

7. The electrode assembly according to claim 1, wherein the negative electrode tab and the negative electrode plate are formed of different metals.

8. The electrode assembly according to claim 7, wherein the negative electrode tab is formed of nickel and the negative electrode plate is formed of copper.

9. The electrode assembly according to claim 1, wherein the positive electrode plate comprises:
a positive electrode collector;
a positive electrode coating portion coated with a positive electrode active material on one or both sides of the positive electrode collector; and
a positive electrode non-coating portion not coated with the positive electrode active material in the positive electrode collector.

10. The electrode assembly according to claim 1, wherein the negative electrode plate comprises:
a negative electrode collector;
a negative electrode coating portion coated with a negative electrode active material on one or both sides of the negative electrode collector; and
a negative electrode non-coating portion not coated with the negative electrode active material in the negative electrode collector.

11. A secondary battery which includes an electrode assembly formed by stacking and winding a positive electrode plate to which a positive electrode tab is joined, a negative electrode plate to which a negative electrode tab is joined, and a separator; and an outer case receiving the electrode assembly, comprising:
a bonded side formed by surface-welding the entire welded part of either the positive electrode tab and the positive electrode plate or the negative electrode tab and the negative electrode plate, or both of the positive electrode tab and the positive electrode plate and the negative electrode tab and the negative electrode plate forming a bonded side.

12. The secondary battery according to claim 11, wherein the outer case is in any one of a pouch shape, a cylindrical shape and a prismatic shape.

13. The secondary battery according to claim 11, further comprising: a protective circuit module on which a protective device is mounted.

14. The secondary battery according to claim 11, wherein the bonded side is formed by high-frequency induction heating.

15. The secondary battery according to claim 11, wherein the bonded side is formed to have a corresponding area to an induction coil for joining the positive electrode plate and the positive electrode tab together or the negative electrode plate and the negative electrode tab together by the high-frequency induction heating.

16. The secondary battery according to claim 11, wherein the positive electrode tab is formed of nickel and the positive electrode plate is formed of aluminum.

17. The secondary battery according to claim 11, wherein the negative electrode tab is formed of nickel and the negative electrode plate is formed of copper.

18. A method of manufacturing an electrode assembly which is formed by stacking and winding a positive electrode plate to which a positive electrode tab is joined, a negative electrode plate to which a negative electrode tab is joined, and a separator, comprising steps of:
providing a fixing jig, for joining the positive electrode tab and the positive electrode plate together or the negative electrode tab and the negative electrode plate together;
providing an induction coil including a terminal to be connected to an external power source;
arranging a plate and an electrode tab by arranging the plate to be joined to the fixing jig and by arranging the electrode tab to be joined between the plate and the induction coil; and
joining the plate and the electrode tab together by electrifying a high-frequency current to the induction coil through the terminal from the external power source.

19. The method according to claim 18, wherein the step of arranging the plate and the electrode tab is arranging the electrode tab to be joined to the fixing jig and arranging the plate to be joined between the electrode tab and the induction coil.

20. The method according to claim 18, wherein the step of joining the plate and the electrode tab together performs the joining thereof by heat, which is generated by an eddy current formed on the surfaces of the plate and the electrode tab by magnetic flux generated by the high-frequency current, and by pressure, which is applied by an electromagnetic force generated in proportion to the electrified current and the magnetic flux.

21. A method of manufacturing an electrode assembly which is formed by stacking and winding a positive electrode plate to which a positive electrode tab is joined, a negative electrode plate to which a negative electrode tab is joined, and a separator, comprising steps of:
providing two induction coils each including a terminal to be connected to an external power source, for joining the positive electrode tab and the positive electrode plate together or the negative electrode tab and the negative electrode plate together;
arranging a plate and an electrode tab by arranging the plate between the two induction coils and by arranging the electrode tab between the plate and any one of the two induction coils; and
joining the plate and the electrode tab together by electrifying a high-frequency current to the induction coils through the terminals from the external power source.

22. The method according to claim 21, wherein the step of joining the plate and the electrode tab together performs the joining thereof by heat, which is generated by an eddy current formed on the surfaces of the plate and the electrode tab by magnetic flux generated by the high-frequency current, and by pressure, which is applied by an electromagnetic force generated in proportion to the electrified current and the magnetic flux.

23. The method according to claim 21, wherein the step of arranging the plate and the electrode tab is of arranging the electrode tab between the two induction coils and arranging the plate between the electrode tab and any one of the two induction coils.

24. An electrode assembly manufactured by the method according to claim 18.

25. An electrode assembly manufactured by the method according to claim 21.
